(19) United States
(12) Patent Application Publication
(10) Pub. No.: US 2003/0208890 A1
(43) Pub. Date: Nov. 13, 2003

(54) Casket link

(76) Inventor: Stanley D.C. Kim, Honolulu, HI (US)

Correspondence Address: Eugene Oak, 610 S. Van Ness Ave., Los Angeles, CA, 90005, US

(21) Appl. No.: 10/139,542

(22) Filed: May 7, 2002

(51) Int. Cl. A62B 33/00

(52) U.S. Cl. 27/31

(57) ABSTRACT

A novel real time multimedia communication system links a deceased and the bereaved members of a family. The system of this invention is comprised of three elements: (1) the casket at the burial site installed with a sound and image transferring unit; (2) the family at home controlling the sound/image transfer unit in the casket; and (3) a relay station between the two transfer unit. The sound and image transfer unit, including but not limited to, videophone, computer and video camera combined with audio speakers. The sound and image transfer unit installed in the casket operated by the electric power generated by solar cell plates located on the tomb stone and/or surface ground above the buried casket. Sound messages such as music and voice, and graphic messages such as a letter, picture and moving images are transferred to each other by a wireless and wire relay station such as a website of internet, radio/television station. Power and access codes to the casket installed units are control by the family members. The system of this invention operates 24 hours a day throughout a year. The bereaved family members can send any kind of message to the deceased lover at any time they want and can monitor the state of the casket. Dialogues between the deceased and the family members can be accomplished on real time basis by editing pre-recorded voice and the video messages of the deceased. The bereaved family members can share their memories and happiness with the deceased longer than ever.

The present invention relates to a real time multimedia communication system linking a deceased and the bereaved members of a family.

### BACKGROUND OF THE INVENTION

When a member of a family passes away, the bereaved members fall in a deep sorrow for losing their beloved ones because it is very hard to share the love and moments with the deceased one though they miss the deceased one wishing to talk with. It is impossible for the bereaved members to check the peace of the deceased one's resting space, the casket, before they dig out the grave.

When a patient facing dead, he/she is afraid of being left alone in the dark casket though may believe in the love of the God. But, if the patient knows that the voice, message and a favorite music will come from the bereaved family member even after the death, the fear of death and left being alone will be reduced.

Therefore, it is the purpose of this invention to provide a real time communication system linking the deceased one and the family member to share their love and to take care of the deceased one's resting place always in real time.

1. Field of Invention

This invention relates to a real time multimedia communication system which is comprised of three elements; 1) the casket at the burial site installed with a sound and image transfer unit; 2) the family members at home controlling the sound/image transfer unit in the casket; 3) and a relay station between the two transfer unit for linking the deceased and the bereaved members of the family.

2. Description of the Prior Art

U.S. Pat. No. 6,324,736 Atrio illustrates a funeral casket which includes a video display unit capable of playing a recorded visual images and audio at a funeral service. The recorded message may portray selected events during the life of the deceased and is intended to be observed by mourners at the casket so as to aid the mourners in coping with their sadness by helping them to more vividly recall the deceased, and hopefully, times of happiness in his or her life. Their display unit is not operable when the power is disconnected from the source at funeral place.

U.S. Pat. No. 6,237,202 Agee, et al. illustrates a dish assembly to increase the quality and styling of the casket interior the quality of the memorialization aspect of the casket and memorial service. The assembly is comprised of a foam dish including an opening there through, and a cap panel installed in the opening in the foam dish. Their invention is a decorative interior of a casket.

U.S. Pat. No. 5,813,099 to Stewart shows a burial casket comprising a photographic memorial marker. The photographic memorial marker is provided with a picture for identifying the deceased person in the casket.

U.S. Pat. No. 5,729,921 to Rojas illustrates a burial marker and display box for the preservation of memorabilia and/or ashes of an individual or individuals. Audio and video recordings may also be permanently carried by the marker box to allow visiting individuals to hear and see the memorialized individual or individuals. That invention is for relatives visiting the burial site of the deceased to share the memories and check the preserving status of the grave.

U.S. Pat. No. 5,732,231 to Evans, III illustrates an apparatus located in a funeral establishment for displaying information about a deceased person whose visitation is in the funeral establishment. The apparatus includes a terminal display with one or more visual displays for visually displaying images of the deceased and textual information about the deceased, and audio capabilities to play sound recordings of or about the deceased.

None of the prior arts provides a real time multimedia communication system linking the deceased and the bereaved members of a family and a tool for monitoring the security of the casket/grave far away at home.

### SUMMARY OF THE INVENTION

It is the purpose of this invention to provide a real time multimedia communication system linking a deceased and the bereaved members of a family. The system of this invention is comprised of three elements: (1) the casket at the burial site installed with a sound and image transferring unit; (2) the family at home controlling the sound/image transfer unit in the casket; (3) and a relay station between the two transfer unit.

The sound and image transfer unit, including but not limited to, video phone, computer and video camera combined with audio speakers. The sound and image transferring unit installed in the casket is operated by the electric power generated by solar cell plates located on the tomb stone and/or surface ground above the buried casket. Excess electricity is stored in the rechargeable battery connected with the solar cell and the transferring unit.

Sound messages such as music and voice, and graphic messages such as a letter, picture and moving images are transferred to each other by a wireless and wire relay station such as website of internet, radio/television station. Power and access codes to the casket installed units are control by the family member in the house. The system of this invention operates 24 hours a day throughout a year. Dialogues between the deceased and the bereaved family member can be accomplished on a real time basisby the editing pre-recorded voice and video messages of the deceased. Accordingly, the bereaved family members can share their memories and happiness with the deceased longer than ever.

### BRIEF DESCRIPTION OF FIGURES

FIG. 1 is a schematic diagram of a real time communication system of this invention.

FIG. 2 is a perspective view of the message transfer unit installed in the casket.

FIG. 3 is a schematic drawing of message transfer unit installed in the casket.

FIG. 4a is a schematic drawing of phone connecting system.

FIG. 4b is a schematic drawing of radio music sharing system.

### DETAILED DESCRIPTION OF THE PREFERRED EMBODIMENTS

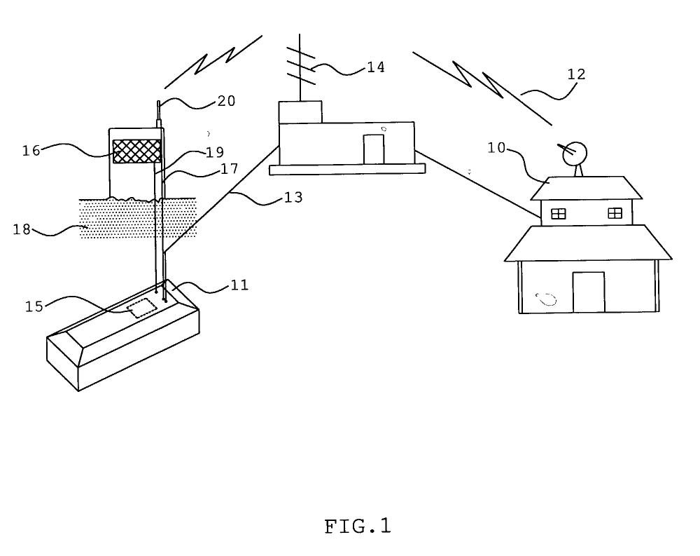

FIG. 1 is a schematic diagram of a real time communication system of this invention. The bereaved members of family in house (10) can send a message to the deceased one in casket (11) by wireless (12) and /or wire (13) via, including but not limited to, a radio station, a television station and an internet station (14). The power for operating the message transfer unit (15) in the casket is supplied from the solar cell plates (16), attached to the tomb stone (17) or on the ground surface (18) above the casket (11), via power line (19) to the message transfer unit (15). The messages transferred via wire less is received by an antenna (20) installed on the tomb stone (17).

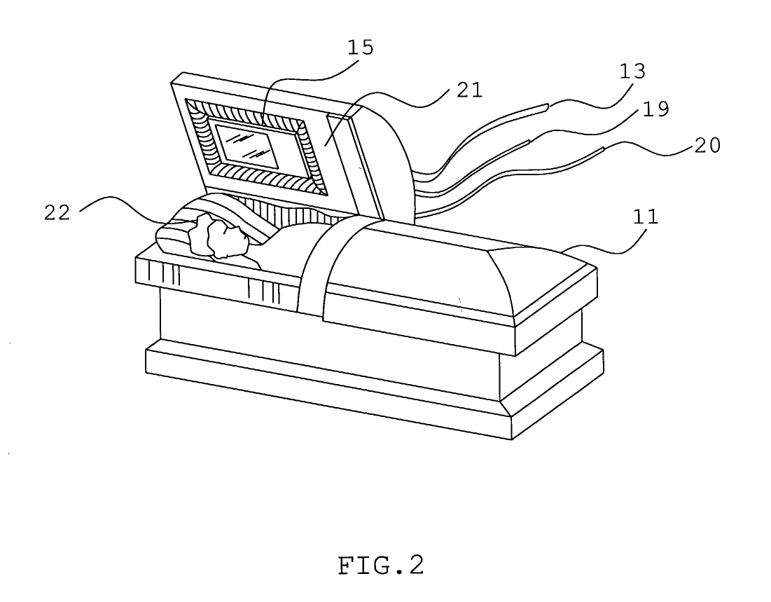

FIG. 2 is a perspective view of the message transfer unit installed in the casket. Three lines of antenna (20), power (19) and cable wire (13) are connected to the message transfer unit (15) in the casket (11). The message transfer unit (15) is attached to the inside of the upper cover (21) of the casket (11) to face the deceased one (22).

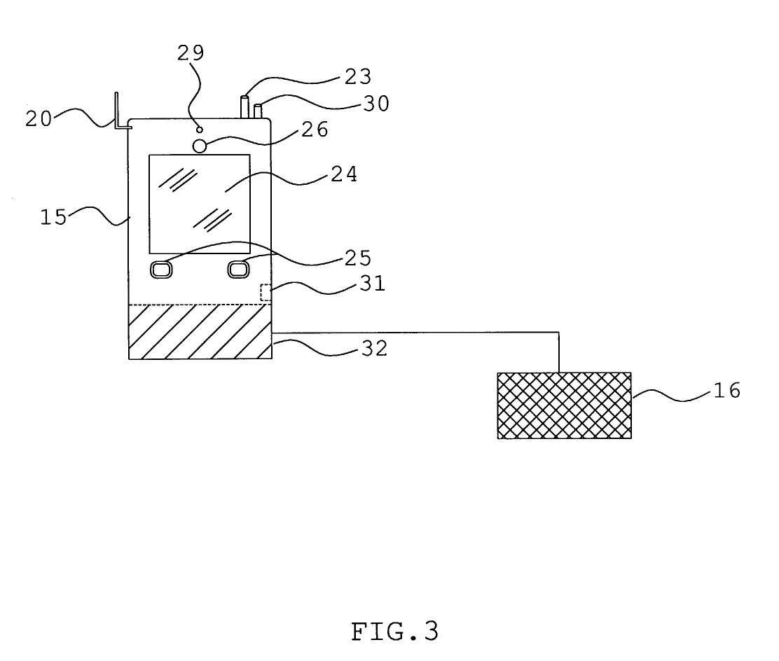

FIG. 3 is a schematic drawing of message transfer unit (15) installed in the casket. The message transfer unit of this invention (15) is capable of transferring audio and video at the same time. The screen (24) is to transfer moving image such as the bereaved family member's face, movie and television news. The speaker (25) is to transfer the voice of the family member and the deceased one's favorite music sent by the family member. A camera (26) is attached to the front face of the unit to monitor the inside of the casket. A light (29) is attached at the top of the front face of the unit to light up the inside of the casket. The antenna (20) on the surface is connected to the transfer unit (15). A cable jacks for internet (23) and wire jack for telephone (30) are attached on the top site of the transfer unit. The remainder can talk directly to the ears of the deceased one by inserting the earphone to the ear of the deceased one and connect the earphone to the earphone jack (31). The transfer unit is operated by the electricity supplied from the rechargeable battery (32) installed inside the unit (15). The battery (32) is connected to the solar cell plates (16) mounted on the tomb stone (17) or on the ground surface (18).

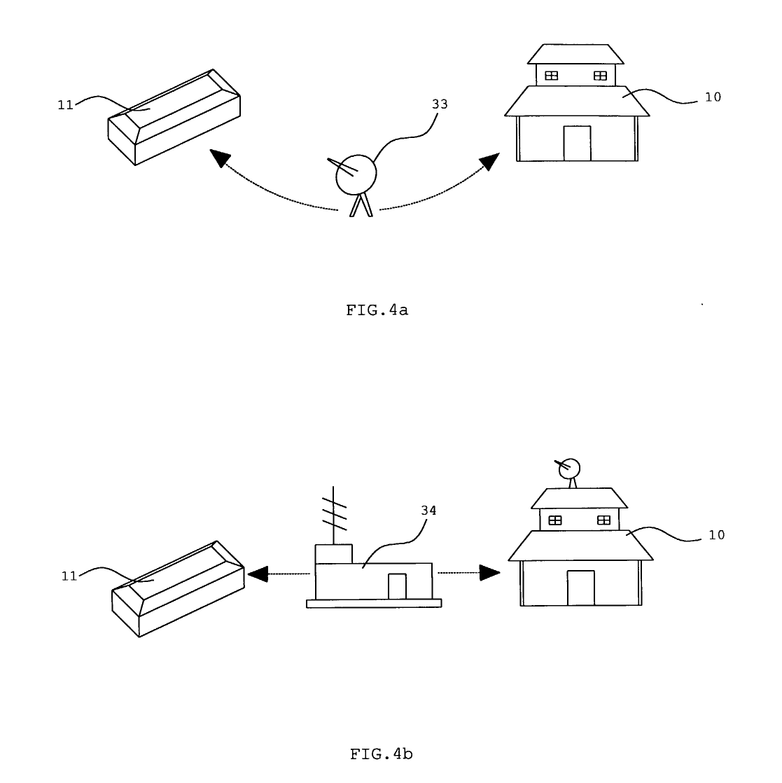

FIG. 4a is a schematic drawing of phone connecting system. Wire and wireless phone are connected via station (33). The dialogues from the casket (11) are those edited at the station (33) from the pre-recorded voice and image of the deceased one to make it feel like talk with the deceased one directly. The grand children, who are born after the death of the deceased one, can see and hear their grand parents as if they are alive and can preserve memories of their ancestors.

FIG. 4b is a schematic drawing of radio music sharing system. The bereaved family members at home (10) select music for the deceased one in casket (11) and make the music play from a radio station (34) at special moments such as the first date of meet, birthday of the deceased one, wedding anniversary and first born of the child. The bereaved one can share the music with the deceased one while talking with the deceased one through the phone system introduced in FIG. 4a.

What is claimed is

1. A real time multimedia communication system, comprised of three elements :1) a casket at the burial site installed with a sound and image, including music, voice, e-mail, picture and moving images, transferring unit, including radio, cellular phone, video-phone, computer and video camera combined with audio speakers being operated by the electric power generated by solar cell plates, located on the tomb stone and surface ground above the buried casket, and stored in the rechargeable battery installed in the transfer unit equipped with AC/DC back up power supply for emergency ; 2) bereaved family member at home controlling the sound/image transfer unit in the casket; 3) a relay station between the two transfer units, linking the deceased and the bereaved members of a family.

2. A real time multimedia communication system, in claim 1, operates 24 hours a day throughout a year by controlling the power and the access codes to the casket installed units by the family member in the house.
